(19) United States
(12) Patent Application Publication
(10) Pub. No.: US 2014/0203097 A1
(43) Pub. Date: Jul. 24, 2014

(54) Selectively dispensing sprays

(71) Applicant: Quantum Sensations, LLC, Cambridge, MA (US)

(72) Inventor: David A. Edwards, Boston, MA (US)

(21) Appl. No.: 14/028,441

(22) Filed: Sep. 16, 2013

Related U.S. Application Data
(63) Continuation of application No. PCT/US2012/029966, filed on Mar. 21, 2012.
(60) Provisional application No. 61/592,559, filed on Jan. 30, 2012.
(60) Provisional application No. 61/528,568, filed on Aug. 29, 2011.
(60) Provisional application No. 61/454,716, filed on Mar. 21, 2011.

(51) Int. Cl. B05B 11/00

(52) U.S. Cl. CPC B05B 11/3045
USPC 239/1; 239/309; 239/305

(57) ABSTRACT

Reloadable devices can dispense, from a single device, multiple sprays that can vary in composition and/or in dose.

### CROSS-REFERENCE TO RELATED APPLICATIONS

This application is a continuation application of and claims priority to PCT/US2012/029966 filed on Mar. 21, 2012, which claims priority to U.S. Provisional Application No. 61/592,559, filed on Jan. 30, 2012; U.S. Provisional Application No. 61/528,568, filed on Aug. 29, 2011; and U.S. Provisional Application No. 61/454,716, filed on Mar. 21, 2011.

### FIELD

The invention relates generally to devices and methods for dispensing aerosols.

### BACKGROUND

Spray devices, ranging from pump sprays to metered dose inhalers, can deliver a drug, a food substance, a perfume or other liquid from a hand-held canister. These devices often deliver multiple doses, or sprays.

### SUMMARY

Reloadable devices can deliver, from a single device, multiple sprays. These sprays can vary in composition and/or in dosage. The sprays can, for example, include: volatile liquids; aerosolized food particles, such as seasonings or powdered chocolate; liquid sprays, such as food colorings; beverages, such as wine, vodka, or flavored waters; dietary supplement formulations, such as vitamins, hormones, minerals; cosmetic or hygienic formulations, such as oral care products; drug formulations, such as drugs that need to be taken in sequence; vaccines; treatments for obesity, anemia, diabetes; or perfumes. In some cases these substances are intended for one or more of the following delivery and/or absorption types: transdermal, oral, buccal, respiratory, enteral, and mucosal. In some cases, these substances are intended for ingestion. In some cases, these substances are meant to be delivered to foods or beverages, e.g., on a plate or in a glass (or in the preparation of foods and beverages), and the food or beverage is to be then consumed normally.

The devices are loaded with one or more replaceable cartridges containing the material being dispensed. Thus, the devices can be used with different materials at different times, or with combinations of materials from different cartridges, according to a user's current preferences and/or, as a cartridge containing a specific material is consumed, the cartridge can be replaced with another cartridge containing the same material, or a different material.

In some embodiments, the handheld aerosol delivery systems can be used to selectably deliver (e.g., spray) various substances (e.g., consumable substances) to a user in small doses delivered and distributed in the form of small droplets, particles, or vapors. As used herein, the term “consumable” refers to substances that are intended to be taken into a user's body by ingestion and/or by transdermal application and/or by mucosal (e.g., buccal or nasal) absorption.

In an aspect, a device includes at least one cartridge defining a reservoir containing a propellant-free, consumable flowable substance and a seal restricting transfer of the consumable substance out of the reservoir, and a dispenser releasably engaged with the at least one cartridge, the dispenser including an aerosolizer operable to selectively dispense the consumable, flowable substance as droplets or particles and an opener placing the reservoir of the at least cartridge in communication with the aerosolizer through the seal.

In an aspect, a device includes a cartridge defining a reservoir containing a propellant-free, consumable flowable substance and a seal restricting transfer of the consumable substance out of the reservoir, the cartridge bring configured to releasably engage a dispenser operable to selectively dispense the consumable, flowable substance as droplets or particles or vapor.

In an aspect, a device includes a dispenser configured to releasably engage in communication with at least one cartridge, the dispenser including an aerosolizer operable to selectively dispense a propellant-free consumable, flowable substance as droplets or particles and an opener placing a reservoir defined by the at least one cartridge in communication with the aerosolizer through a seal restricting transfer of the consumable substance out of the reservoir.

In an aspect, a method of dispensing a consumable substance includes dispensing droplets of a propellant-free, consumable substance that includes a liquid with a vapor pressure greater than 4 kPa at 20 degrees Centigrade, the droplets having a median diameter sized greater than 1 micron, greater than 3 microns, greater than 5 microns, greater than 10 microns, greater than 15 microns, or greater than 20 microns, and/or less than 2 millimeters.

In an aspect, a method of dispensing a consumable substance includes providing at least one cartridge defining a reservoir holding a propellant-free, consumable flowable substance and a seal restricting transfer of the consumable substance out of the reservoir, inserting the at least one cartridge into a dispenser including an aerosolizer operable to selectively dispense the consumable, flowable substance as droplets or particles such that an opener of the dispenser places the reservoir of the cartridge in communication with the aerosolizer through the seal, and dispensing between 1 milligram and 200 milligrams of the consumable, flowable substance by a single actuation of the aerosolizer.

In some embodiments, the method further includes puncturing the seal with the opener.

In some embodiments, the method further includes actuating a pump (e.g., manually actuating a pump).

In an aspect, a system includes a housing defining a first reservoir and a second reservoir, a seal member that is changeable between a state in which the seal member restricts dispensing of material out of the first and second reservoirs and a state in which the seal member does not restrict dispensing of material out of the first and second reservoirs, and a dispenser with an outlet, the dispenser being operable to selectively connect the outlet to the first reservoir, to the second reservoir, or to the first and second reservoirs.

In an aspect, a method of dispensing aerosol includes simultaneously dispensing a first material and a second material from a handheld device in which the first material and the second material are stored in different reservoirs in the handheld device, and then opening the handheld device to load material into at least one of the first and the second reservoirs.

In an aspect, a system includes a fluid dispenser having a fluid inlet and an opener disposed along the fluid inlet, and a fluid cartridge having a seal restricting fluid flow out of the fluid cartridge, the fluid cartridge configured to be removably attached to the fluid dispenser, where the opener of the fluid dispenser is inserted through the seal of the fluid cartridge when the fluid cartridge is removably attached to the fluid dispenser.

In some embodiments, the consumable, flowable substance is a liquid (e.g., an alcohol) with a vapor pressure greater than 4 kPa at 20 degrees Centigrade.

In some embodiments, the consumable, flowable substance includes flavoring agents (e.g., spices, pepper flavoring, tea flavoring, cherry flavoring, cactus flavoring, cinnamon powder, pepper powder, cayenne chili pepper, or capsaicin).

In some embodiments, the consumable, flowable substance includes vitamins (e.g., Vitamins A or Vitamin C) and/or medicaments (e.g., testosterone, estrogen, estradiol, vaccine, sugar for diabetics, treatments for the obese, or phlegm reduction agents) and/or dietary supplements (e.g., resveratrol or iron for anemia) and/or cosmetic/hygienic agents (e.g., agents for controlling bad breath, oral cleanliness, or skin moisture).

In some embodiments, the reservoir of the at least one cartridge has a volume of less than 5 ml (e.g., less than 4 ml, less than 3 ml, less than 2 ml, or less than 1 ml).

In some embodiments, the aerosolizer dispenses between 1 milligram and 200 milligrams of the consumable, flowable substance per actuation, particularly wherein the aerosolizer dispenses droplets of the consumable, flowable substance with droplets or particles of a median diameter sized greater than 1 micron, greater than 3 microns, greater than 5 microns, greater than 10 microns, greater than 15 microns, greater than 20 microns, and/or less than 2 millimeters.

In some embodiments, the seal includes a puncturable lid (e.g., a metal foil lid or a plastic lid).

In some embodiments, the aerosolizer includes a pump (e.g., a manual pump).

In some embodiments, the device also includes a second seal formed by engagement between the cartridge and the dispenser, the second seal channeling communication of the consumable flowable substance from the reservoir to the aerosolizer.

In some embodiments, the aerosolizer dispenses between 1 milligram and 200 milligrams of the consumable, flowable substance per actuation.

In some embodiments, the first reservoir is sized to receive a sealed cartridge containing material to be dispensed and the second reservoir is sized to receive a sealed cartridge containing material to be dispensed.

In some embodiments, the first reservoir is larger than the second reservoir.

In some embodiments, the system includes an opening member configured to release the material to be dispensed from a sealed cartridge received in the first reservoir.

In some embodiments, the system includes a third reservoir.

In some embodiments, the dispenser is operable to selectively connect the outlet to the first reservoir, the second reservoir, and the third reservoir, individually or in combination.

In some embodiments, the system includes six reservoirs, each reservoir having a reservoir outlet with a first distance between outlets of adjacent reservoirs. In some cases, the dispenser defines two conduits with inlets spaced apart by the first distance. In some cases, the dispenser is rotatably mounted to the housing such that rotation of the dispenser selectively aligns the inlets of the conduits of the dispenser with outlets of two adjacent reservoirs.

In some embodiments, the dispenser includes a spray pump.

In some embodiments, the first reservoir is sized to receive a canister containing pressurized material to be dispensed and the second reservoir are sized to receive a canister containing pressurized material to be dispensed.

In some embodiments, the dispenser includes a trigger operable to actuate a canister containing pressurized material received in the first reservoir.

In some embodiments, a first material is disposed in the first reservoir and a second material, different than the first material, is disposed in the second reservoir. In some cases, the first material and the second material include components selected from the group of: food particles; beverages; foods capable of flowing; drug formulations; and perfumes.

In one aspect, a system includes: a housing defining a first reservoir and a second reservoir; a seal member changeable between a state in which the seal member restricts transfer of material out of the first and second reservoirs and a state in which the seal number does not restrict transfer of material out of the first and second reservoirs; and a dispenser with an outlet, the dispenser operable to selectively connect the outlet to the first reservoir, to the second reservoir, or to the first and second reservoirs. Embodiments can include one or more of the following features.

In some embodiments, the first reservoir is sized to receive a sealed cartridge containing material to be dispensed and the second reservoir is sized to receive a sealed cartridge containing material to be dispensed. In some cases, the first reservoir is larger than the second reservoir. In some cases, systems include an opening member configured to release the material to be dispensed from a sealed cartridge received in the first reservoir.

In some embodiments, systems include a third reservoir. In some cases, the dispenser is operable to selectively connect the outlet to the first reservoir, the second reservoir, and the third reservoir, individually or in combination.

In some embodiments, systems include six reservoirs, each reservoir having a reservoir outlet with a first distance between outlets of adjacent reservoirs. In some cases, the dispenser defines two conduits with inlets spaced apart by the first distance. In some cases, the dispenser is rotatably mounted to the housing such that rotation of the dispenser selectively aligns the inlets of the conduits of the dispenser with outlets of two adjacent reservoirs.

In some embodiments, the first reservoir is sized to receive a canister containing pressurized material to be dispensed and the second reservoir is sized to receive a canister containing pressurized material to be dispensed. In some cases, the dispenser comprises a trigger operable to actuate a canister containing pressurized material received in the first reservoir. In some cases, a propellant is used.

In some embodiments, a first material is disposed in the first reservoir and a second material, different from the first material, is disposed in the second reservoir. In some cases, the first material and the second material comprise components selected from the group consisting of: food particles; beverages; liquefied (e.g., dissolved) foods; food emulsions; foods capable of flowing; drug formulations; dietary-supplement formulations; cosmetic formulations; perfumes.

In one aspect, methods of dispensing aerosol include: simultaneously dispensing a first material and a second material from a handheld device in which the first material and the second material are stored in different reservoirs in the handheld device; and then opening the handheld device to load material into at least one of the first and the second reservoirs.

The devices, systems, and methods described can provide one or more of the following advantages.

The systems can provide the advantage that reloadable cartridges can be inserted into the devices and the spray pump/trigger mechanism can be rotated or shifted to connect with multiple cartridges. It is also possible to connect the spraying mechanism to each reloadable cartridge via two (or more) tubes and therefore have the option of the two tubes feeding the spray nozzle either from the same reservoir cartridge or from two (or more) cartridges therefore permitting the mixing of two or more liquids according to the design preferences of the user.

The systems are also simple and easy to construct. Embodiments incorporating a spray pump enable use of non-pressurized cartridges. Moreover, the straightforward approach to simultaneously accessing multiple cartridges can avoid the need for precise registration of actuators and the release valves of pressurized cartridges.

The systems can produce aerosols of substances, such as liquid droplets (e.g., alcohol or spicy liquids droplets) that have a high surface-area-to-volume ratio, which increases volatilization. Absorption through membranes, such as those in the mouth, may increase. Dissolution in liquids, such as saliva in the mouth, may increase. The overall rate of delivery of the substances to the body may increase. Such increased absorption permits enhanced tasting and smelling of the substances and can cause a user to enjoy the taste and experience of a substance, such as alcohol, without having to consume the high levels of the substance that would otherwise typically be employed. These alcohol delivery techniques can permit a user to experience the effects of an alcoholic beverage while consuming much less of the alcohol.

The systems can also produce aerosols of substances, such as transdermal vitamins or hormonal supplements that can be absorbed into the body more easily than via some other application or ingestion techniques.

The details of one or more embodiments of the invention are set forth in the accompanying drawings and the description below. Other aspects, features, and advantages of the invention will be apparent from the description and drawings, and from the claims.

### DESCRIPTION OF DRAWINGS

FIG. 1 is a schematic view of an aerosol dispenser having a reusable pump device and a disposable fluid cartridge.

FIGS. 2A and 2B are cross-sectional views of an exemplary reusable aerosol dispenser pump device and associated disposable fluid cartridge, in pre-assembled state and in assembled state, respectively.

FIGS. 3A and 3B are cross-sectional views of an exemplary reusable aerosol dispenser pump device and associated disposable fluid cartridge, in pre-assembled state and in assembled state, respectively.

FIGS. 4A and 4B are assembly and exploded views, respectively, of an exemplary reusable aerosol dispenser pump device and associated disposable fluid cartridge.

FIGS. 4C and, 4D are cross-sectional views of the exemplary reusable aerosol dispenser pump device and associated disposable fluid cartridge of FIG. 4A.

FIGS. 4E and 4F are perspective views of elements of the exemplary reusable aerosol dispenser pump device and associated disposable fluid cartridge of FIGS. 4A and 4B.

FIG. 5A is an exploded perspective view of an aerosol dispenser.

FIG. 5B is a top view of the cap of the housing of the aerosol dispenser of FIG. 5A.

FIG. 6A is a perspective view of an aerosol dispenser.

FIG. 6B is a perspective view of the aerosol dispenser of FIG. 6A disassembled for reloading.

FIG. 6C is a perspective view of the aerosol dispenser of FIG. 6A in use.

FIG. 7A is a perspective view of an aerosol dispenser disassembled for reloading.

FIG. 7B is a perspective view of a pivoting member and spray pump of FIG. 7A.

FIGS. 8A and 8B are perspective views of an aerosol dispenser.

### DETAILED DESCRIPTION

Handheld aerosol delivery systems that can be used to deliver one or more aerosols can be implemented as a device with reloadable cartridges that are punctured upon insertion into the device and permit recharging of the device with replacement materials to be sprayed. In some embodiments, the handheld aerosol delivery systems can be used to deliver (e.g., spray) various substances (e.g., consumable substances) to a user in small doses delivered and distributed in the form of small droplets or particles or vapor.

For example, using the handheld aerosol delivery systems, the user can spray a substance (e.g., liquid) into his/her mouth in order to experience the taste, mouth feel, or effect of the liquid without requiring full consumption. For example, a user can spray alcoholic liquids (e.g., liquids resembling wine or cocktails) into his/her mouth to deliver a distribution of fine droplets of the alcoholic liquid inside his/her mouth. The fine droplets possess a generally large surface area to volume ratio, which typically increases volatilization and provides an enhanced sense of smell and taste with even low doses. Therefore, the distribution of fine droplets can be absorbed quickly by the membranes within the mouth, and/or be deposited for ingestion and enteral absorption, and/or interact with olfactory cells, and cause the user to feel the sensation of consuming alcoholic liquids without consuming a significant volume of alcoholic liquids. The low volumes dispensed limit the effects of consumption, such as increases in blood alcohol concentrations. In some cases, the fine droplets may cause a user to feel pleasurable effects of the alcoholic liquids for a reduced time period.

The configuration and procedure for use of the device, can significantly impact the ways in which a consumer is likely to use it. For example, if the device is made of high-quality, relatively expensive materials, and makes use of relatively small cartridges which need to be replaced regularly, this can promote moderated use of the device, thus moderating any intake of the substance to be delivered.

For example, the sprays described in more detail below typically contain about 50-100 micro-liters per “spray actuation” (or “spraying”), while a single beverage shot (e.g., of vodka) is typically about 40-60 mL. Thus, a single spray delivers about the same amount of alcohol as about 1/1000 of a shot. Although there is little alcohol per spraying, the spraying (e.g., by creating fine droplets that are about 10 microns in diameter) increases the surface area in contact with air (of the ˜75 microliter volume) by at least, for example, about 1000 times. While reducing the volume of alcohol by a factor of 1000, a vapor pressure that is sufficient to stimulate, to some extent, the sensation of alcohol consumption (since the quantity of vapor is correlated linearly with the surface area of the exposed liquid) can be maintained. Based on initial testing, it appears that 75 microliter sprays have sufficient volume to provide an expected and authentic-seeming vodka taste/stimulation.

Other edible substances can be delivered in order to obtain a desired sensation without consuming typical amounts of the substances. For example, handheld aerosol delivery systems can deliver fine droplets of a spicy substance to simulate consuming a spicy food or beverage. As in the delivery of alcoholic liquids, testing indicated that 75 microliter sprays seem to produce a sufficient volume to provide an authentic spice taste/stimulation.

In addition to delivering alcoholic liquids or other edible substances, the handheld aerosol delivery systems can also deliver other substances, such as vitamins, hormonal supplements, medicines, or hygiene products. For example, in some embodiments, the handheld aerosol delivery systems deliver transdermal vitamins or hormonal supplements that are sprayed on the skin of a user. Similar to fine droplets sprayed into the mouth, as discussed above, transdermal vitamins or hormonal supplements can be delivered to the skin in the form of fine droplets or particles having a high surface area to volume ratio. The fine droplets or particles can then be absorbed by the skin and into the bloodstream of the user more rapidly than some other vitamins or hormonal supplements applied to the skin. Further, in some embodiments, the handheld aerosol delivery systems are used to delivery hygiene products (e.g., oral hygiene products) that can be applied to surfaces in the mouth, and/or absorbed rapidly in the mouth. In some embodiments, these vitamins, hormonal supplements, medicines, or hygiene products also include some amount of alcohol, which is anticipated to serve as an enhancer for the transdermal transfer of associated substances. Other agents that can enhance transdermal delivery include, for example, alkyl methanol sulphoxides, surfactants, oleic acid, and azone.

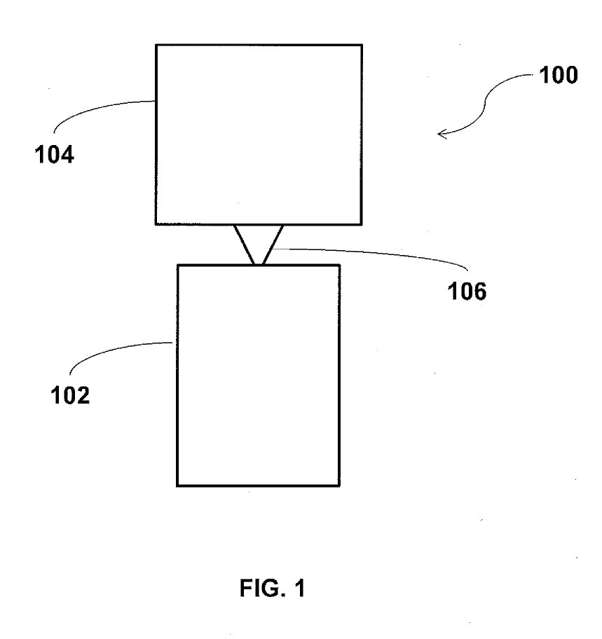

Referring to FIG. 1, a handheld aerosol delivery system 100 can include a disposable cartridge 102 and a reusable dispenser 104. In this embodiment, the reusable dispenser is a manual pump, but some embodiments may include other dispensing mechanisms. The reusable pump device 104 is designed to be temporarily placed in communication with and disposed atop the disposable cartridge 102 so that substances (e.g., liquids) can be dispensed from the disposable cartridge 102. Terms of orientation (e.g., upper, lower, top, bottom, right, and left) as used in this description refer to the relative orientation of components of the systems shown in the figures rather than to imply an absolute orientation.

When assembled for use, an opening member 106 (e.g., a blade or sharpened tube) of the reusable pump device 104 penetrates the disposable cartridge 102 (e.g., a seal on the disposable cartridge 102) so that the substances can be dispensed by the reusable pump device 104. Once the substances are dispensed from the disposable cartridge 102, the disposable cartridge 102 can be removed so that another disposable cartridge 102 can be positioned in its place. While the opening member 106 has been described as a blade penetrating the disposable cartridge 102, other configurations for placing the disposable cartridge 102 and the reusable pump device 104 in fluid communication are possible. For example, the opening device 106 can include other devices to cut, pierce, separate, melt, grind, or perform other opening techniques to place the disposable cartridge 102 and the reusable pump device 104 in communication so that substances within the disposable cartridge 102 can be dispensed using the reusable pump device 104.

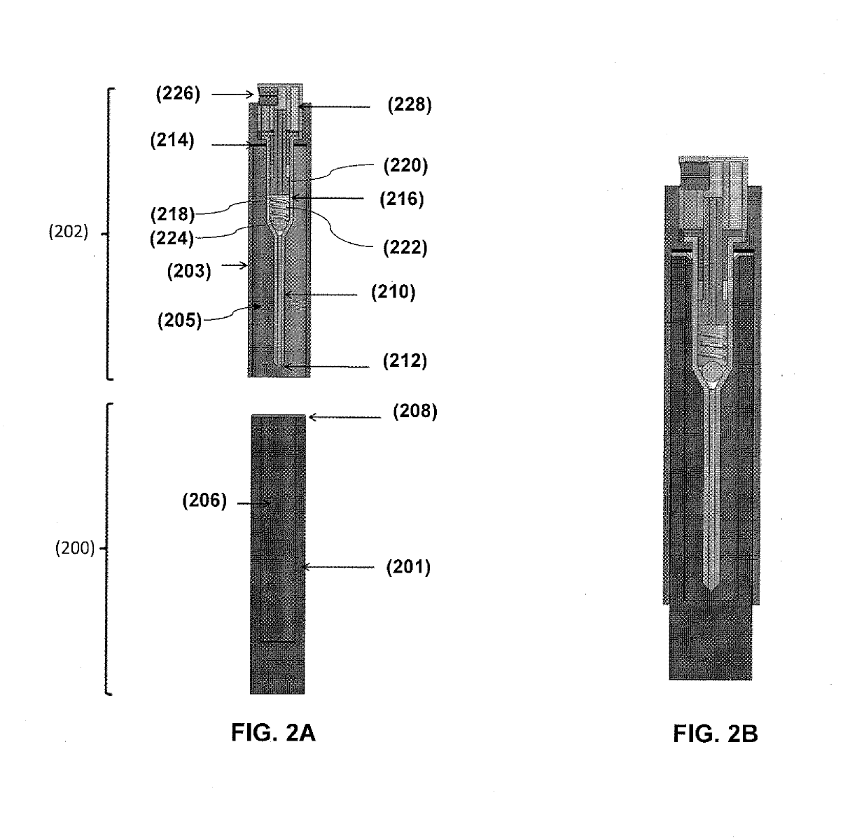

FIGS. 2A and 2B illustrate an example of a reusable pump device 202 and an associated disposable cartridge 200. The disposable cartridge 200 includes a body 201 defining a reservoir 206 that is sized to engage the reusable pump device 202 and has a seal (e.g., a pierceable foil lid) 208 along the top surface to secure the reservoir 206 containing a substance. In the example shown, the disposable cartridge 200 is sized to contain about 1 mL in the reservoir 206. In some embodiments, the reservoir 206 is sized to contain more or less of a substance. For example, the reservoir 206 can contain less than 1 mL (e.g., about 0.05 ml to about 1 mL). The reservoir 206 can contain more than 1 mL (e.g., about 2 mL, about 1 mL to about 100 mL, about 1 mL to about 50 mL, about 1 mL to about 25 mL, about 1 mL to about 10 mL, about 1 mL to about 5 mL, about 5 mL to about 10 mL, about 5 mL to about 20 mL, or other volumes of a substance to be dispensed).

The reusable pump device 202 includes a cover body 203 defining a cavity 205 that is sized and configured to receive a portion or all of the disposable cartridge 200 when inserted. The cover body 203 encloses a dip tube 210 having a sharpened edge 212 that penetrates the foil lid 208 of the disposable cartridge 200 when the disposable cartridge 200 is inserted into the reusable pump device 202. As the disposable cartridge 200 is fully inserted into the reusable pump device 202, the foil lid 208 deforms about the dip tube 210, and the top surface of the disposable cartridge 200 seats and seals against a sealing gasket 214 of the reusable pump device 202. This mechanism can provide a clean, leak-resistant connection between the disposable cartridge 200 and the pump device 202. Once the disposable cartridge 200 is fully inserted, as shown in FIG. 2B, the cover body 203 receives the disposable cartridge 200 so that the dip tube 210 reaches the bottom surface, or reaches nearly to the bottom surface of the reservoir 206 so that it can dispense most or all of the liquid contained in the disposable cartridge 200. Also, once fully seated, the disposable cartridge 200 can be retained by the reusable pump device 202 using mechanisms such as, for example, a quarter-turn style luer lock connection, threads, snap-on detents, a press-fit, magnets, or the like.

The material of the dip tube 210 should be sufficiently rigid such that torsion that might be applied during insertion of the disposable cartridge 200 does not cause the dip tube 210 to bend. In some implementations, a guide path may be created (e.g., using alignment features) within the cavity 205 of the cover body 203 and/or the body 201 of the disposable cartridge 200 so that each disposable cartridge inserted and engaged into the pump device 202 has very little margin for error during the insertion and engagement process, and the puncture and penetration of the dip tube 210 into the disposable cartridge 200 is sure, simple, and effective.

The dip tube 210 has a sharp end 212 to effectively puncture the foil lid 208 of the disposable cartridge 200 and limit wear that could cause the sharp end 212 to wear, and finally become ineffective after multiple punctures. The material of the dip tube 210 can be polymeric with wall thickness selected to provide necessary rigidity. The material is typically chosen from polymers that are chemically and physically stable in the presence of alcohol, water, and other materials that might be included in food, cosmetic, and drug liquid formulations. In some embodiments, the dip tube material is metal, ceramic, or other similar rigid material. The design of the sharp end 212 of the tube 210 also reduces the likelihood that the dip tube 210 will be plugged by cartridge material while puncturing the seal of the cartridge or during use.

The disposable cartridge 200 and the reusable pump 202 can be made of various materials that provide suitable structural and chemical properties. For example, materials are typically selected to be resistant to degradation that could result from contact with the substance contained and delivered by the disposable cartridge 200 and the reusable pump 202. Examples of suitable materials include plastics (e.g., polymers, such as polyethylene), glass, metals (e.g., aluminum), composites, or other rigid material resistant to degradation from contact with the substances described herein. The foil lid 208 arranged on an upper end of the disposable cartridge 200 is generally made of a puncturable material such as, for example, metal foil or plastic.

In some embodiments, communication between the disposable cartridge 200 and the pump device 202 is provided by direct engagement between the disposable cartridge 200 and the pump device 202 using aligned apertures in the two components. In some embodiments, the aerosol dispensing devices have other connection mechanisms such as, for example, connector tubing (not shown) capable of providing a spill-resistant connection that provides protection against contamination of substances being transferred between the disposable cartridge 200 and the pump device 202.

A pump mechanism 216 is contained within an upper enlarged portion 218 of the dip tube 210. The pump mechanism 216 is a manually actuated pump, including a piston 220, a cylinder (e.g., an enlarged portion of the dip tube) 218, a spring 222, a one-way valve 224, and a nozzle 226 disposed in a spray head 228. A user presses down on and releases the spray head 228 to dispense a dose of substance from the reservoir 206. When the spray head 228 is released, the spring 222 forces the piston 220 upward. The resulting low pressure within the cylinder 218 causes the one-way valve 224 to open and induces a portion of substance to flow from the reservoir 206, up through the dip tube 210, and into the cylinder 218 priming the pump mechanism 216. The user then presses down on the spray head 228 again, forcing the substance dose up through a hole in the piston 220 and out of the nozzle 226, with the one-way valve 224 restricting the substance from flowing back down the dip tube 210. The amount of substance dispensed each time the spray head 228 is pressed can be varied, for example, based on the travel length of the spray head 228 and piston 220, and size and diameter of the piston 220 (e.g., the hole in the piston 22) and the dip tube 210. In this example, each actuation of the pump mechanism produces a pumped dose of about 0.04 mL of substance from the reservoir 206. In some embodiments, the dose delivered by each pump actuation may be different. For example, the pumped dose can be about 50 to about 200 milligrams. The user can continue to dispense doses of the substance using the pump mechanism 216 until the substance level in the reservoir 206 becomes so low that it can no longer be accessed by the dip tube 210. The disposable cartridge 200 can then be removed from the reusable pump device 202 and a new disposable cartridge 200 can be installed for use.

Such dispensers can also be implemented using other pumping/discharge mechanisms. In some instances, a moving element in a disposable cartridge 200 can force the substance in disposable cartridge 200 into a nozzle that atomizes/sprays the substance. In some instances, gravity and/or capillarity is used to help move the substance in disposable cartridge 200 into a nozzle that atomizes/sprays the substance. For example, in some instances, the disposable cartridges 200 are pressurized and, rather than a pump device, the dispensers include a trigger mechanism configured to release the contents of the disposable cartridges 200. In some instances, the disposable cartridges 200 are fluidly connected to propellants that help direct the substance in the disposable cartridges 200 to the reusable pump device 202.

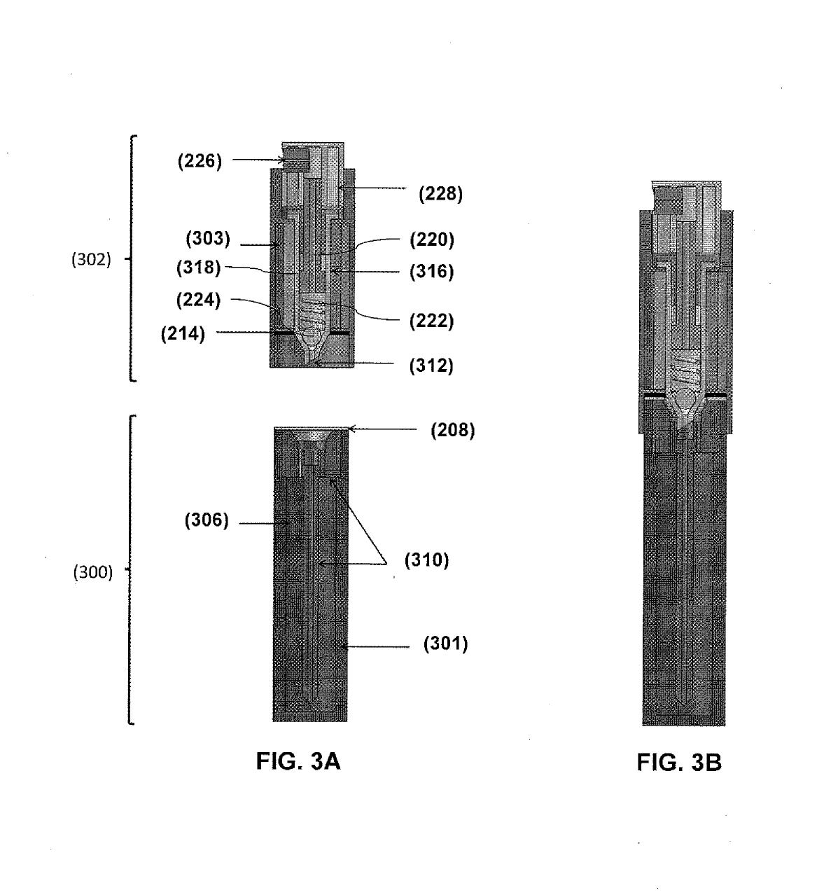

FIGS. 3A and 3B shows another example of a reusable pump device 302 and an associated disposable cartridge 300. The reusable pump device 302 includes a cover body 303 to contain and support a pump mechanism 316 for dispensing a substance from the disposable cartridge 300. The disposable cartridge 300 includes a body 301 defining a reservoir 306 that contains the substance to be dispensed. In contrast to the pump device and disposable cartridge shown in FIGS. 2A and 2B, a dip tube 310 of this exemplary device is a component of the disposable cartridge 300 (and not a component of the reusable pump device 302). The reusable pump device 302 has a sharpened edge 312 along a bottom edge of a pump cylinder 318 to penetrate the foil lid 208 on the disposable cartridge 300, i.e., instead of a sharpened edge positioned along the bottom edge of the dip tube (as in the pump device 202 discussed above). During assembly, once the sharpened edge 312 penetrates the foil lid 208, the lower surface of the pump cylinder 318 abuts and seals against the top portion of the dip tube 310 so that the substance in the reservoir 306 can be dispensed from the disposable cartridge 300. To dispense the substance, the pump mechanism 316 in this device can be operated in a manner similar to that discussed above with regards to the pump mechanism 216 in the example of FIGS. 2A and 2B. As discussed above, the disposable cartridge 300 can also be retained by the reusable pump device 302 using mechanisms such as, for example, threads, snap-on detents, a press-fit, or magnets.

The device shown in FIGS. 3A and 3B has several additional benefits, e.g., as compared to the device shown in FIGS. 2A and 2B. For example, the aerosol dispenser shown in FIGS. 3A and 3B has a much shorter penetrating member, i.e., only the short portion of the pump cylinder, as opposed to the entire dip tube, being inserted through the foil lid. This configuration may reduce the risk of spills by permitting more rapid assembly with reduced risk of misalignment and/or spilling before the sealing gasket engages the disposable pump cartridge. Additionally, the reusable pump device shown in FIGS. 3A and 3B can be used with various shapes and sizes of disposable cartridges having receptacles configured to receive and engage the penetration portion of pump device. For example, disposable cartridges that are taller, shorter, wider, or narrower, and/or that have a reservoir having a capacity that is greater or less than that of the disposable cartridge 300, can be used.

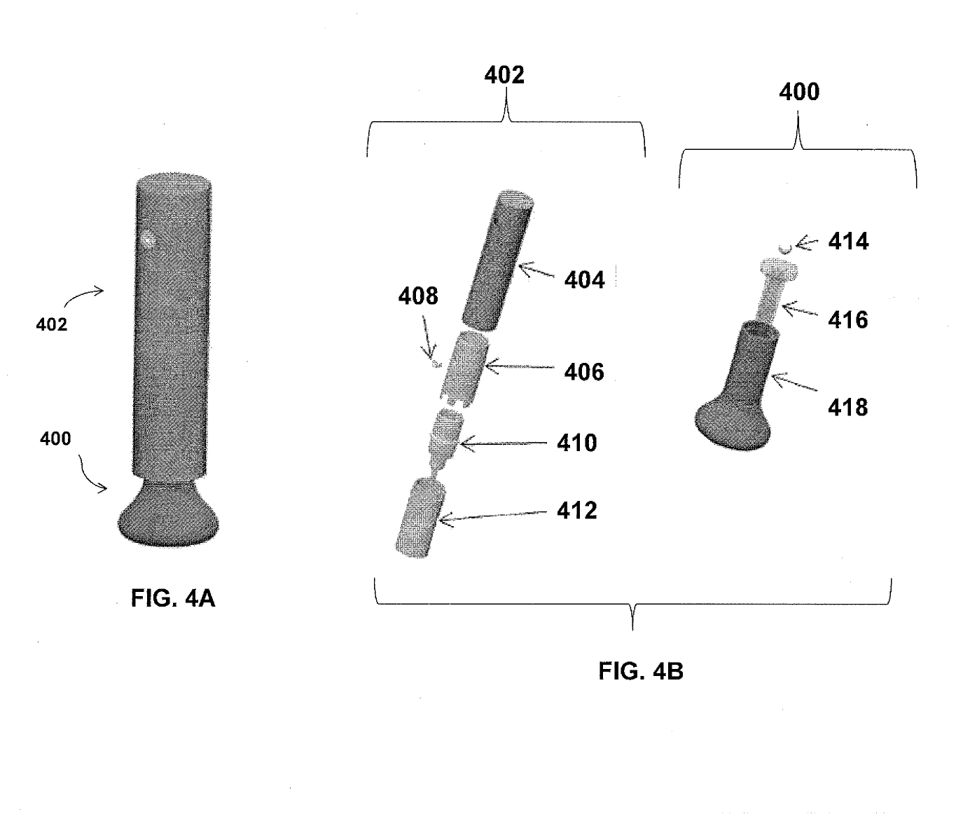

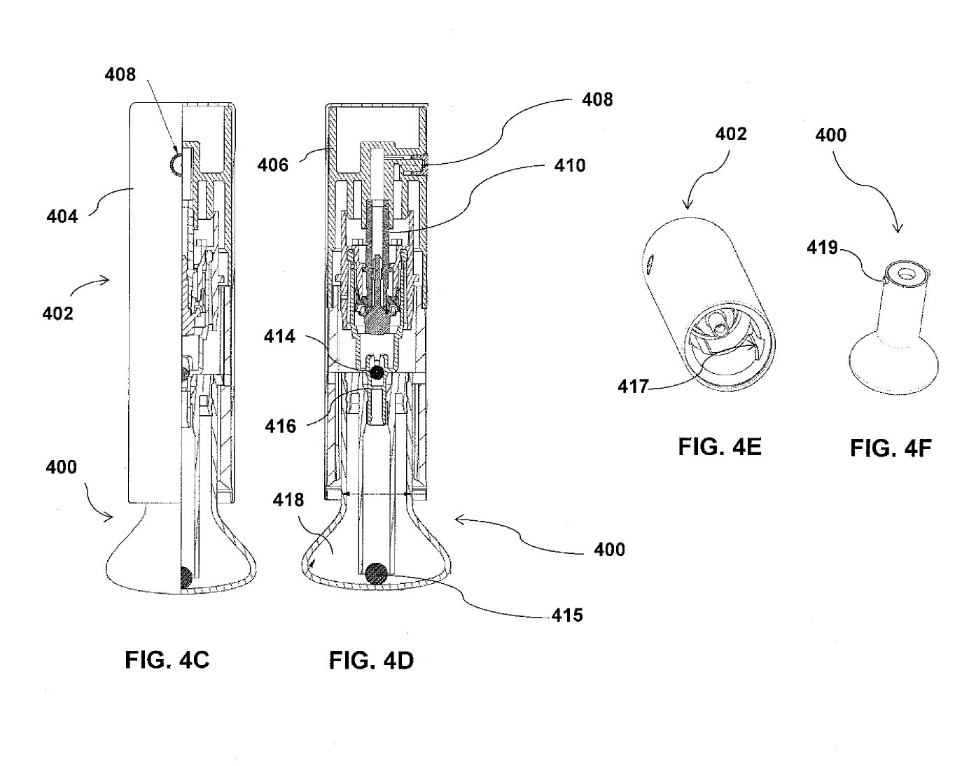

FIGS. 4A-4F show an example of a reusable pump device 402 and an associated disposable cartridge 400. The pump device 402 includes a cover 404, a head 406, a nozzle 408, a pump 410, and an insert 412. The nozzle 408 is received in the sidewall aperture of the head 406. The head 406 is inserted into the cover such that the nozzle 408 is aligned with an aperture defined in a sidewall of the cover 404. The pump 410 is disposed within and between the head 406 and the insert 412. The disposable cartridge 400 includes a first ball 414 disposed in an insert tube 416. The insert tube 416 extends into a reservoir 418. In this embodiment, the insert tube 416 is part of the disposable cartridge 400. As shown in FIGS. 4C and 4D, a second ball 415 is arranged at a generally lower region of the insert tube 416. The spray is actuated (i.e., caused to generate a spray from the contents of the disposable cartridge 400) by applying a compression force that moves the disposable cartridge 400 closer to the cover 404, and/or moves the cover 404 closer to the disposable cartridge 400, substantially along the central axis between the cartridge 400 at the “bottom” and the cover 404 at the “top” (these positions only being relative to each other). The two balls 414, 415 are configured such that, upon actuation of the pump device 402, the balls alternately seal, or provide access to, the insert tube. This, respectively, restricts, or allows, the substance in the disposable cartridge 400 to be pumped toward the nozzle and released from the device as a spray. In this embodiment, the suction effect of the pump 410 drives the substance up toward the nozzle 408. The disposable cartridge 400 can be retained within the pump device 402 using, for example, a quarter-turn luer lock style connection. FIGS. 4E and 4F are perspective views of the pump device 402, and of the disposable cartridge 400. As shown, the pump device 402 defines a recess 417 and the disposable cartridge 400 includes two opposing bosses 419 protruding from its outer surface. When the disposable cartridge 400 is inserted into the pump device 402, the bosses 419 are guided along the recess 417 and the disposable cartridge 400 is rotated relative to the pump device 402 to secure the disposable cartridge 400 within the pump device 402.

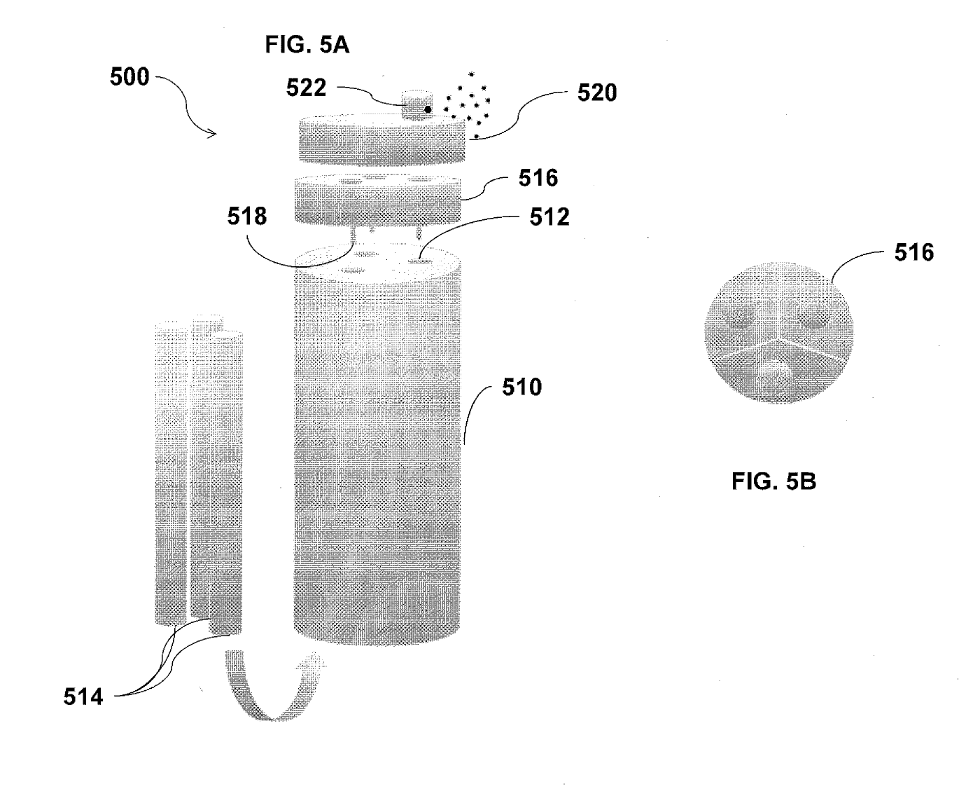

While FIGS. 1 through 4F illustrate systems for delivery of a substance from a single reservoir, other configurations are possible. For example, FIGS. 5A and 5B illustrate an exemplary system 500 for delivering aerosols of one or more different types of substances. The delivery system 500 includes a housing 510 defining a plurality of recesses 512 sized to removably receive spray cartridges 514 (e.g., disposable sterile cartridges). After the spray cartridges 514 are inserted into the recesses 512, a cap 516 is attached to the housing 510 to hold the spray cartridges 514 in place within the recesses 512. The cap 516 includes rigid tubes 518 that extend downward to pierce the tops of the spray cartridges 514.

The cap 516 defines bumps or a lip (not shown) that snap into corresponding recesses (not shown) in the housing 510 to releasably secure the cap 516 and the housing 510 together as a unit. To reload the system 500 with new spray cartridges 514, a user applies pressure to disengage the cap from the recesses to release this engagement. A top view of the cap 516 is shown in FIG. 5B.

A pivoting member 520 including a spray pump 522 is mounted to the cap 516 such that a user can rotate the pivoting member 520 relative to the housing to selectively align an inlet of the pump 522 with one of tubes 518 leading to a particular spray cartridge. Thus, the pivoting member 520 can be rotated to selectively align the spray pump 522 with the many reservoirs in the system 500 and, therefore, enable dispensing of multiple different substances from a single device.

The system 500 can be implemented with many different types of spray pumps. In some instances, the spray cartridges 514 are pressurized and, rather than a spray pump, the systems include a trigger mechanism configured to dispense the contents of the spray cartridges. In some instances, the material to be dispensed can be placed directly in the recesses 512. This approach uses the recesses 512 as open reservoirs holding the material to be dispensed rather than as receptacles for spray cartridges 514. The cap 516 holds the material to be dispensed in the recesses 512 until the system 500 is activated. In these embodiments, the tubing 518 can be flexible as it is no longer used to break the seal on a spray cartridge 514. The tubes 518 are long enough to extend to the bottom of the recesses 512.

In this embodiment, the system 500 has, e.g., three recesses 512. In some instances, system 500 is implemented with other numbers of recesses 512 (e.g., 2, 4, 5, 6, or more). The recesses 512 and associated spray cartridges 514 can all be the same size, e.g., as shown in FIGS. 5A and 5B, or the recesses 512 and associated spray cartridges 514 can have different sizes. For example, if the system 500 were configured to dispense food coloring (or other situations where one or more substances are likely to be used preferentially, in greater volume), the system 500 could be implemented with one or more recesses 512 significantly larger than the other recess(es) 512. In preparation for use, a large spray cartridge 514 of the color (e.g., blue) anticipated to be used the most would be inserted into the larger recess 512 and smaller spray cartridges 514 of the other colors (e.g., yellow and red) would be inserted into the other two recesses 512. As another example, different spices that are typically used in different quantities on foods may be used. A large spray cartridge 514 of the spice (e.g., salt or salt solution) anticipated to be used more frequently than other would be inserted into the larger recess 512 and smaller spray cartridges 514 of the other spices (e.g., pepper, pepper in liquid form, or other liquid flavorings) would be inserted into the other two recesses 512.

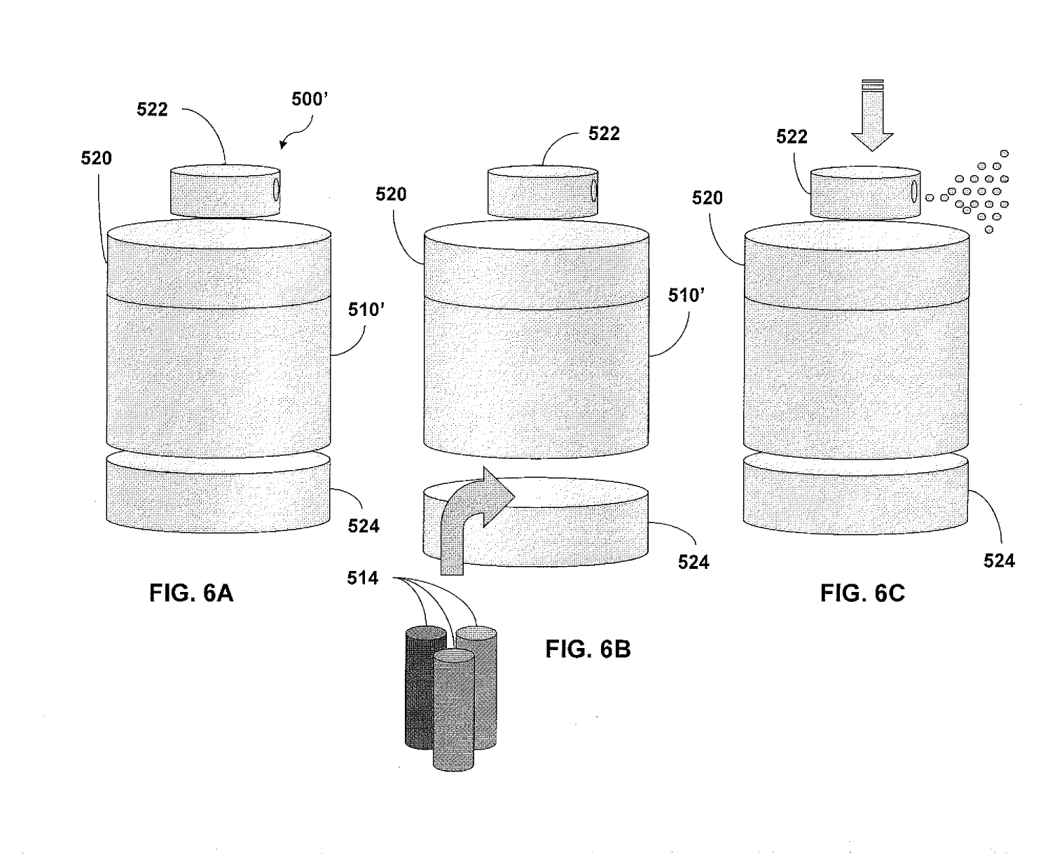

In the system 500 (shown in FIGS. 5A and 5B), the spray cartridges 514 can be removed and inserted into the spray system 500 by opening the device and placing the cartridges in the recess. In some systems, the housing 510 and the cap 516 of the illustrated system 500 are replaced by a housing 510′ (see FIGS. 6A-6C), which incorporates the rigid tubes 518. In these embodiments, the recesses 512 extend from the bottom (rather than from the top) of the housing 510′. As shown in FIGS. 6A-6C, a base 524 can be removed from the bottom of the housing 510 (shown in FIG. 6A), the spray cartridges 514 are inserted into the recesses from the bottom of the housing 510′ (shown in FIG. 6B), and the base 524 is re-attached to the housing 510′ to secure the spray cartridges 514 in place (shown in FIG. 6C). In both configurations, the act of inserting or closing the device over new cartridges breaks a seal on the cartridges and permits the contents (e.g., liquid) to be dispensed via the device.

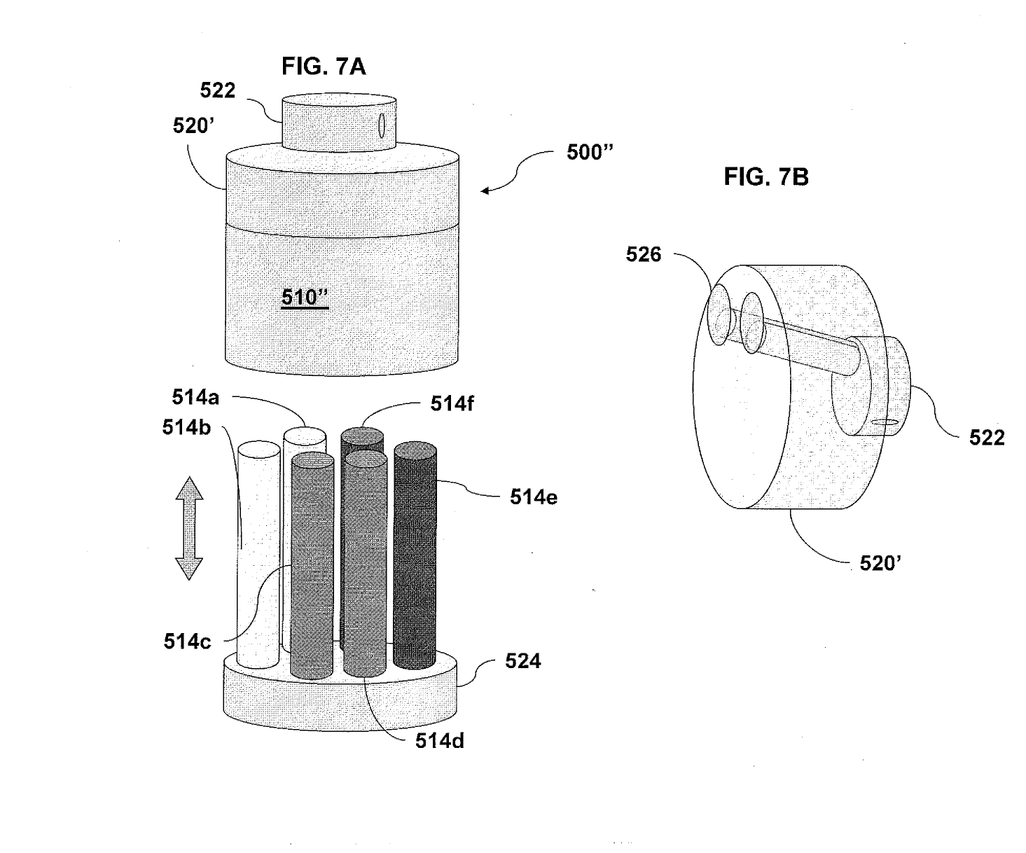

Systems can also be implemented to selectively dispense mixtures of any number or combination of different materials (e.g., the materials in the cartridges 514). For example, a system 500″ (shown in FIGS. 7A and 7B) is substantially similar to the system 500′ (shown in FIGS. 6A-6C). However, the system 500″ defines recesses to receive up to six spray cartridges 514. The spray cartridges 514 can be inserted into the housing 510′ such that pairs of spray cartridges 514 containing the same material are grouped together. The pivoting member 520′ defines two tubes/apertures 526 connecting spray cartridges 514 with the spray pump 522. Depending on the relative spatial/radial orientation of the spray pump 522 and pivoting member 520 with two feeding tubes 526, and the housing 510 and spray cartridges, the device can dispense a single material or can dispense a mixture of two materials. For example, if the pivoting member 520′ is rotated such that the two feeding tubes 526 are aligned with adjacent spray cartridges 514a, 514b containing the same material, the system 500″ will dispense that material. However, if the pivoting member 520′ is rotated such that the two feeding tubes 526 are aligned with adjacent spray cartridges 514b, 514c containing different materials, the system 500″ will dispense a mixture of the two materials. While the system 500″ is shown having six spray cartridges 514, the system can be designed to accommodate a different number of cartridges. For example, fewer spray cartridges (e.g., two, three, four, or five cartridges) or more spray cartridges (e.g., seven, eight, nine, ten, or more cartridges) could be accommodated.

The systems 500, 500′, 500″ can provide the advantage that disposable cartridges can be inserted into the devices and the spray pump can be rotated to connect with multiple cartridges. It is also possible to connect the spraying mechanism to each reloadable cartridge via two (or more) tubes and therefore have the option of the two tubes feeding the spray nozzle either from the same reservoir cartridge or from two (or more) cartridges therefore permitting the mixing of two or more liquids according to the design preferences of the user. The device may be of various sizes and shapes, the materials may be plastic, glass, metal or other appropriate material, the liquids may be alcohol, such as wine or vodka, or flavored waters, or any beverage, or drug formulations, or perfumes, and other liquids.

The devices can include both single- and multi-cartridge embodiments. In the single- or multi-cartridge embodiments, the devices are configured such that the cartridges containing the liquid formulation are spill proof and sufficiently sealed to remain clean or sterile (depending on the precise use). The cartridge, which may be long/slender/cylindrical, but may take other forms (e.g., disc-shaped, elliptical, or spheroidal), have an “end” that can be inserted into the spray device and that will be punctured or opened or otherwise “connected” by the insertion, allowing communication between the spray pump and the liquid contents of the cartridge.

In some embodiments, each spray option provided by the device (i.e., if it is a triple spray device, there are three options, or three cartridges that are inserted into the spray) has a tube integral to the spray device and that, upon insertion of the cartridge, will pierce the “end” of the cartridge such that the tube enters the cartridge following the insertion motion. If the spray is then used in a vertical or near-vertical orientation, the devices are configured such that the tube reaches the bottom (or nearly reaches the bottom) of the cartridge (relative to vertical orientation) when the cartridge is fully engaged with (e.g., inserted into) the dispenser. In some cases, the tube has only an opening only at the end of the tube, i.e. at the bottom of the cartridge. In some cases, the tube has openings at other points along the axis of the tube, thus allowing liquid to be dispensed from the cartridge when in a non-vertical orientation.

The devices described above can be used to dispense liquid and/or aerosol sprays of substances formulated to provide an intense sensation with low levels of secondary systemic/digestive/hepatic side effects or other undesirable effects (e.g., over-absorption by the liver). Such substances can deliver initial sensations (e.g., taste and cerebral effect) that are similar to the experience, for example, of vodka or hot sauce. The effect of the spray is to generate higher vapor per mass of liquid and therefore to enhance the alcohol effect and/or the spice effect. However, very little mass of the substance is dispensed into the body—so blood levels of alcohol or the volumes of spicy things in the stomach are very low, and, similarly, only relatively small amounts of some of the other, less desirable contents of the alcohol or spicy things are ingested by the user.

The ingredients for three example formulations are listed in Table 1, Table 2, and Table 3.

TABLE 1
Hot Sauce Sensation

| ID | Source | Ingredient | Mass |
|---|---|---|---|
| | | Alcohol 96% by volume | 22 |
| | Evian | Water | 73.4 |
| 10826264 | IFF | Pepper Flavoring | 0.3 |
| 539222C | Firmenich | Rooibos Tea Natural Flavoring | 0.6 |
| 01-129-06 | AM Todd | Cherry Flavoring | 0.5 |
| 505898SE | Firmenich | Cactus Flavoring | 0.4 |
| | | Cinnamon Powder | 0.1 |
| | | Espelette Pepper Powder | 1 |
| | | Cayenne Chili Pepper | 0.2 |
| AA112103 | Naturex | Capsaicin (10% ethanol) | 1.5 |

| | | |
|---|---|---|
| Total | 100 | g |

TABLE 2
Hot Sauce Sensation

| ID | Source | Ingredient | Mass |
|---|---|---|---|
| | | Alcohol 96% by volume | 40 |
| | Evian | Water | 55.4 |
| 10826264 | IFF | Pepper Flavoring | 0.3 |
| 539222C | Firmenich | Rooibos Tea Natural Flavoring | 0.6 |
| 01-129-06 | AM Todd | Cherry Flavoring | 0.5 |
| 505898SE | Firmenich | Cactus Flavoring | 0.4 |
| | | Cinnamon Powder | 0.1 |
| | | Espelette Pepper Powder | 1 |
| | | Cayenne Chili Pepper | 0.2 |
| AA112103 | Naturex | Capsaicin (10% ethanol) | 1.5 |

| | | |
|---|---|---|
| Total | 100 | g |

TABLE 3
Shot Sensation

| ID | Source | Ingredient | Mass |
|---|---|---|---|
| | | Alcohol 96% by volume | 60.000 |
| | Firmenich | “Cooling Mix” Flavoring | 0.100 |
| | Evian | Water | 39.600 |
| | IFF | “Tingle” Flavoring | 0.300 |

| | | |
|---|---|---|
| Total | 100 | g |

The spice concentrations (with alcohol) in the first two formulations (hot sauce sensations shown in Tables 1 and 2) are very high, and the alcohol level in the third formulation (shot sensation shown in Table 3) is also very high (e.g., 60 proof). Even at the low quantities dispensed per spray, the user feels the experience and has enough of an effect to ‘enjoy the spicy taste’ or ‘enjoy a vodka.’

These formulations can be packaged in 2 ml or smaller volume cartridges. They are all dispensed as sprays, with up to about 200 mg per spray dose and as small as about 50 mg per spray dose. All the formulations deliver an experience (e.g., an experience similar to eating Tabasco® sauce for the first and second formulations, and the taste and small cerebral effect of ingesting vodka for the third formulation) with only relatively low levels of side effects.

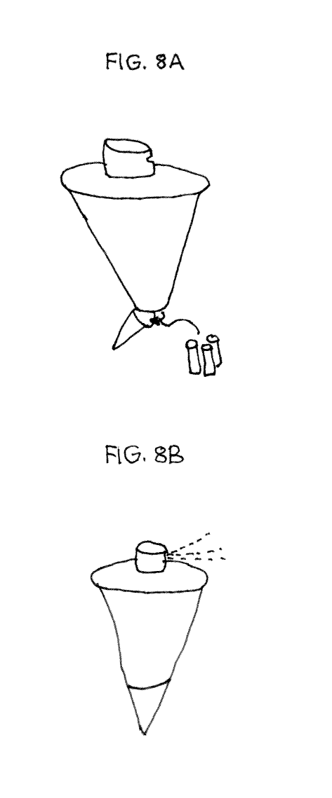

A number of embodiments have been described. Nevertheless, it will be understood that various modifications may be made without departing from the spirit and scope of this disclosure For example, although the systems shown in FIGS. 1A-7B have generally cylindrical shapes, such systems can be implemented in other shapes, e.g., such as the conical shape shown in FIGS. 8A and 8B. While the devices and systems described herein have been described as generally being used to dispense certain substances, such as aerosols of fluid droplets, other substances can be dispensed. For example, in some embodiments, the devices and systems described herein can dispense aerosols of small solid or semi-solid particles. Accordingly, other embodiments are within the scope of the following claims.

What is claimed is:

1. A device comprising at least one cartridge defining a reservoir containing a propellant-free, consumable flowable substance and a seal restricting transfer of the consumable substance out of the reservoir, the cartridge configured to releasably engage a dispenser operable to selectively dispense the consumable, flowable substance as droplets or particles or vapor.

2. The device of claim 1, wherein the consumable, flowable substance comprises a liquid with a vapor pressure greater than 4 kPa at 20 degrees Centigrade.

3. The device of claim 2, wherein the reservoir has a volume of less than 5 ml.

4. The device of claim 3, wherein the seal comprises a puncturable lid.

5. The device of claim 1, further comprising a dispenser configured to releasably engage in communication with the at least one cartridge, the dispenser including an aerosolizer operable to selectively dispense a propellant-free consumable, flowable substance as droplets or particles and an opener placing a reservoir defined by the at least one cartridge in communication with the aerosolizer through a seal restricting transfer of the consumable substance out of the reservoir.

6. The device of claim 5, wherein the aerosolizer dispenses between 1 milligram and 200 milligrams of the consumable, flowable substance per actuation.

7. The device of claim 5, wherein the aerosolizer dispenses droplets of the consumable, flowable substance with a median diameter sized greater than 1 micron and less than 2 millimeters.

8. The device of claim 5, wherein the aerosolizer comprises a pump (e.g., a manual pump).

9. A method of dispensing a consumable substance, the method comprising:
providing at least one cartridge defining a reservoir holding a propellant-free, consumable flowable substance and a seal restricting transfer of the consumable substance out of the reservoir;
inserting the at least one cartridge into a dispenser including an aerosolizer operable to selectively dispense the consumable, flowable substance as droplets or particles such that an opener of the dispenser places the reservoir of the cartridge in communication with the aerosolizer through the seal; and
dispensing between 1 milligram and 200 milligrams of the consumable, flowable substance by a single actuation of the aerosolizer.

10. The method of claim 9, wherein the consumable, flowable substance comprises a liquid with a vapor pressure greater than 4 kPa at 20 degrees Centigrade.

11. The method of claim 9, comprising puncturing the seal with the opener.

12. The method of claim 11, comprising actuating a pump (e.g., manually actuating a pump).

13. A system comprising:
a housing defining a first reservoir and a second reservoir;
a seal member changeable between a state in which the seal member restricts dispensing of material out of the first and second reservoirs and a state in which the seal member does not restrict dispensing of material out of the first and second reservoirs; and
a dispenser with an outlet, the dispenser operable to selectively connect the outlet to the first reservoir, to the second reservoir, or to the first and second reservoirs.

14. The system of claim 13, wherein the first reservoir is sized to receive a sealed cartridge containing material to be dispensed and the second reservoir is sized to receive a sealed cartridge containing material to be dispensed.

15. The system of claim 14, wherein the first reservoir is larger than the second reservoir.

16. The system of claim 15, comprising an opening member configured to release the material to be dispensed from a sealed cartridge received in the first reservoir.

17. The system of claim 13, comprising a third reservoir.

18. The system of claim 17, wherein the dispenser is operable to selectively connect the outlet to the first reservoir, the second reservoir, and the third reservoir, individually or in combination.

19. The system of claim 13, comprising six reservoirs, each reservoir having a reservoir outlet with a first distance between outlets of adjacent reservoirs.

20. The system of claim 19, wherein the dispenser defines two conduits with inlets spaced apart by the first distance.

21. The system of claim 20, wherein the dispenser is rotatably mounted to the housing such that rotation of the dispenser selectively aligns the inlets of the conduits of the dispenser with outlets of two adjacent reservoirs.

22. The system of claim 21, wherein the dispenser comprises a trigger operable to actuate a canister containing pressurized material received in the first reservoir.

23. The system of claim 13, wherein a first material is disposed in the first reservoir and a second material, different than the first material, is disposed in the second reservoir.
